(19) United States
(12) Patent Application Publication
(10) Pub. No.: US 2012/0016627 A1
(43) Pub. Date: Jan. 19, 2012

(54) APPARATUS FOR ESTIMATING LOCATION OF VEHICLE AND PROGRAM EXECUTED THEREBY

(75) Inventor: Michinaga NAGURA, Kariya-shi (JP)

(73) Assignee: DENSO CORPORATION, Kariya-city (JP)

(21) Appl. No.: 13/181,650

(22) Filed: Jul. 13, 2011

(30) Foreign Application Priority Data
Jul. 14, 2010 (JP) 2010-159961

(51) Int. Cl. G06F 15/00

(52) U.S. Cl. 702/150

(57) ABSTRACT

An on-vehicle apparatus adapted to estimate a location of a subject vehicle, in which the apparatus acquires vehicle-information including a location, a velocity and a running direction of the subject vehicle at a reference time and a factor that changes the velocity of the subject vehicle. The on-vehicle apparatus predicts a location of the subject vehicle at an object time which is advanced from the reference time based on the acquired factor

### CROSS-REFERENCE TO RELATED APPLICATION

This application is based on and claims the benefit of priorities from earlier Japanese Patent Application No. 2010-159961 filed on Jul. 14, 2010, the descriptions of which are incorporated herein by reference.

### BACKGROUND

1. Field of the Invention

The present invention relates to an apparatus for estimating location of a vehicle and a program adapted to estimate the location of the vehicle.

2. Description of the Related Art

Conventionally, an apparatus used for estimating a location of a vehicle is known. For example, Japanese Patent Application Laid-Open Publication No. 2007-066261 discloses an apparatus adapted to estimate the location of the vehicle assuming the vehicle travels at a constant velocity.

However, in the apparatus used for estimating the location of the vehicle, it is considered that the accuracy for detecting the location of the vehicle declines when the vehicle to be detected is accelerating or decelerating.

An embodiment provides an apparatus estimating a location of a subject vehicle. As a first aspect of the embodiment, the location-estimating apparatus includes: vehicle-information acquiring means for acquiring information about the subject vehicle at a reference time, the information including a location, a velocity and a running direction of the subject vehicle; factor acquiring means for acquiring a factor that changes the velocity of the subject vehicle; and location predicting means for predicting a location of the subject vehicle at an object time which is advanced from the reference time.

According to the above-described on-vehicle apparatus, since the apparatus estimates the location of the subject vehicle based on the factor that changes the velocity of the subject vehicle at the reference time. The accuracy of estimating the vehicle-location can be enhanced compared to estimating the vehicle running at a constant velocity.

According to the location-estimating apparatus, as a second aspect of the embodiment, the vehicle-information acquiring means includes other-vehicle-information acquiring means for acquiring the information about other vehicles than the subject vehicle by using inter-vehicle communication, and the location predicting means includes other-vehicle-location predicting means for predicting the location of other vehicle by using the inter-vehicle communication.

According to the above-described location-estimating apparatus, the location of other vehicles can be estimated by using the inter-vehicle communication.

Moreover, as a third aspect of the embodiment, when the location-estimating apparatus is mounted on a vehicle, the vehicle-information acquiring means includes own-vehicle-information acquiring means for acquiring the information about an own vehicle as the subject vehicle, the factor acquiring means includes own-vehicle-factor acquiring means for acquiring the factor that changes the velocity of the own vehicle, and the location predicting means includes own-vehicle-location predicting means for predicting the location of the own vehicle.

Hence, according to the location-estimating apparatus as described above, the location of the own vehicle can be estimated as well.

As a fourth aspect of the embodiment, the location-estimating apparatus may include vehicle-behavior predicting means for predicting behavior of the own vehicle and other vehicle collision calculating means for calculating a probability of collision between the own vehicle and other vehicle based on the behaviors predicted by the vehicle-behavior predicting means.

According to the above-described location-estimating apparatus, detecting accuracy can be enhanced so that accuracy of calculating the probability of collision can be enhanced as well.

As a fifth aspect of the embodiment, the vehicle-behavior predicting means includes region calculating means for calculating regions at a plurality of object times advanced from the reference time (i.e., future times), the regions being specified such that the own vehicle and other vehicles are likely to exist therein and having plural regions discriminated by a probability of the own vehicle and other vehicles being present in the region, and the collision calculating means comprises determining means for determining the probability of collision based on whether or not the regions mutually overlap at each of the object times.

In the above-described apparatus, the probability of the collision can readily be determined depending on an amount of area overlapped in the respective estimated regions. Moreover, as a sixth aspect of the embodiment, the above-described apparatus may include alert means configured to generate an alert in response to the probability of collision and to give the alert.

Since the above-described apparatus is adapted to output an alert in response to the probability of collision, the driver can be notified of possible collision. According to the above-described apparatus, as a seventh aspect of the embodiment, the factor acquiring means is configured to acquire speed limit information as the factor that changes the velocity of the subject vehicle, and the location predicting means is configured to predict the location of the subject vehicle assuming the velocity of the subject vehicle is less likely to accelerate to exceed the speed limit.

The above-described location-estimating apparatus is adapted to estimate the location of the subject vehicle assuming a low probability of the velocity of the vehicle exceeding the speed limit whereby the detecting accuracy of the subject vehicle can be enhanced.

Moreover, as a eighth aspect of the embodiment, the factor acquiring means can be configured to acquire information about acceleration/deceleration capability of the subject vehicle, and the location predicting means can be configured to predict the velocity of the subject vehicle based on the information about the acceleration/deceleration capability and to predict the location of the subject vehicle.

According to the above-described apparatus, acceleration/deceleration range i.e., velocity range can be estimated based on the acceleration/deceleration capability of the subject vehicle so that accuracy of detecting location of the subject vehicle can be enhanced.

As a location-estimating program that estimates a location of a subject vehicle, the program is executed on the above-described location-estimating apparatus. The location-estimating program includes: vehicle-information acquiring program for acquiring information about the subject vehicle at a reference time, the information including a location, a velocity and a running direction of the subject vehicle; factor acquiring program for acquiring a factor that changes the velocity of the subject vehicle; and location predicting program for predicting a location of the subject vehicle at an object time which is advanced from the reference time.

According to the above-described program, at least similar advantages of the first aspect of the embodiment can be obtained.

### BRIEF DESCRIPTION OF THE DRAWINGS

In the accompanying drawings:

FIG. 1 is a block diagram showing an overall configuration of a vehicle control system according to the embodiment;

FIGS. 2A and 2B are explanatory diagrams showing an overall processing according to the embodiment;

FIG. 3 is a flowchart showing support processing;

FIG. 4 is a flowchart showing a location predicting procedure;

FIG. 5 is a graph showing a velocity distribution of pattern 1;

FIG. 6 is a graph showing a velocity distribution of pattern 2;

FIG. 7 is a graph showing a velocity distribution of pattern 3;

FIG. 8 is a graph showing a velocity distribution of pattern 4 (before reaching the speed limit);

FIG. 9 is a graph showing a velocity distribution of pattern 4 (after reaching the speed limit);

FIG. 10A is a graph showing a velocity distribution of pattern 5;

FIG. 10B is a graph showing an acceleration factor distribution of pattern 6; and

FIGS. 11A and 11B are schematic diagrams each explaining about probability of collision between the own vehicle and other vehicle, to be calculated.

### DETAILED DESCRIPTION OF THE PREFERRED EMBODIMENTS

With reference to the drawings, hereinafter will be described an embodiment according to the present invention.

### Configuration of the Embodiment

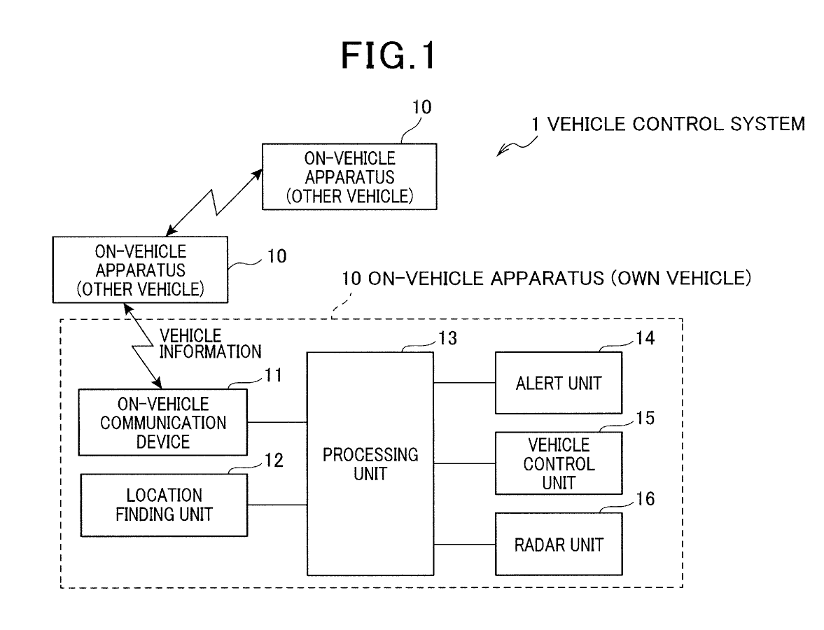

FIG. 1 is a block diagram showing an overall configuration of a vehicle control system 1 according to the present invention. The vehicle control system 1 is provided with an on-vehicle apparatus 10 (location-estimating apparatus) which is mounted on a plurality of vehicles running on the road.

Each on-vehicle apparatus 10 mounted on the respective vehicles is adapted to be capable of performing inter-vehicle communication with on-vehicle apparatuses 10 mounted on other vehicles. Since the respective on-vehicle apparatuses 10 are configured to have similar configuration, one of those on-vehicle apparatuses 10 is described in detail with reference to FIG. 1.

As shown in FIG. 1, the on-vehicle apparatus 10 includes an on-vehicle communication device 11, a location finding unit 12, a processing unit 13, an alert unit 14, a vehicle control unit 15 and a radar unit 16. The on-vehicle communication device 11 is configured as a radio communication apparatus, and performs inter-vehicle communication in which vehicle-information about the own vehicle is transmitted to other on-vehicle apparatus 10 in response to a command by the processing unit 13 and the vehicle-information transmitted by other on-vehicle apparatus 10 is received.

The on-vehicle communication device 11 mutually exchanges the vehicle information periodically e.g., every 100 millisecond, the vehicle information including details such as a location, velocity and acceleration factor of the own vehicle, length/width of the own vehicle and acceleration/deceleration capability of the own vehicle such as maximum acceleration, a maximum speed. It is noted that the acceleration/deceleration factor can be set depending on drive-characteristics as driven by the user.

The location finding unit 12 is configured to specify the location of the own vehicle and the running direction of the own vehicle based on detected signals from a vehicle velocity sensor, a GPS receiver, optical-beacon, acceleration sensor and a gyroscope or the like and to output the specified data to the processing unit 13.

The alert unit 14 includes a display unit and a speaker, and is configured to display an alert to the driver in response to a command from the processing unit 13 and to generate a sound including an alert-sound.

The radar unit 16 is configured as a known radar device such that the radar unit 16 emits electromagnetic waves or laser light towards the running direction (forward direction) of the own vehicle and detects the reflected waves to detect a distance between other vehicles and the own vehicle. The radar unit 16 is designed to detect the distance between the own vehicle and other vehicles at constant intervals e.g., 100 millisecond and to transmit the detected result to the processing unit 13.

The processing unit 13 and the vehicle control unit 15 are configured as a known microprocessor that includes CPU (central processing unit), ROM (read only memory), RAM (random access memory). The processing unit 13 performs various types of processing such as driving support (described later). Specifically, the processing unit 13 employs data detected by the location finding unit 12 and the radar 16, and performs the processing based on the program (for estimating location of a vehicle) stored in the own memory device such as ROM.

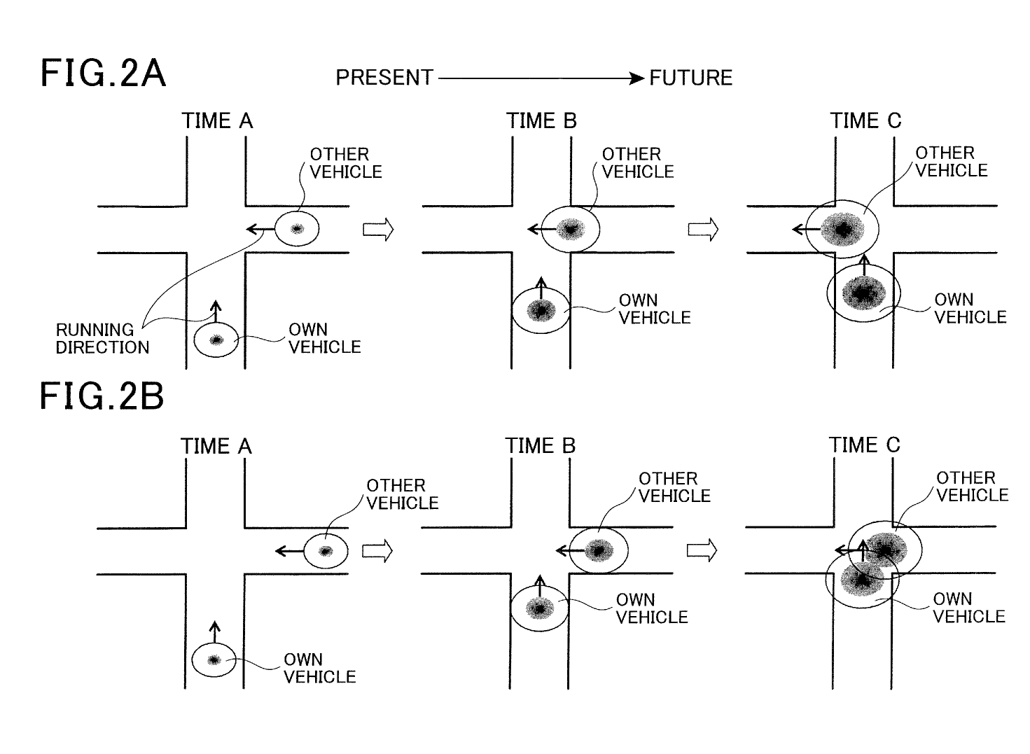

The vehicle control unit 15 executes driving support performing a braking operation or the like based on the program stored in the own memory device such as ROM. With reference to FIGS. 2A and 2B, the processing performed in the vehicle control system according to the embodiment is now described as follows. In FIGS. 2A and 2B, it is noted that the three time points (time A, B, C) are exemplified and time A represents current time and time B and C are future time points.

In the on-vehicle apparatus 10 according to the embodiment, as shown in FIG. 2A and FIG. 2B, the on-vehicle apparatus 10 estimates locations of the own vehicle and vehicles running close to the own vehicle at the present time and the future, as estimated regions for the respective vehicles. Then, the on-vehicle apparatus 10 calculates the probability of collision between the own vehicle and the other vehicle based on whether or not the estimated regions overlap in the same timing, and outputs an alert as necessary.

According to an example as shown in FIG. 2A, even when the respective estimated regions approach an intersection, the estimated regions do not overlap (see FIG. 2A) so that the alert is not outputted. On the other hand, as shown in FIG. 2B, the estimated regions overlap when the estimated regions approach the intersection (see right chart in FIG. 2B) so that the alert is outputted.

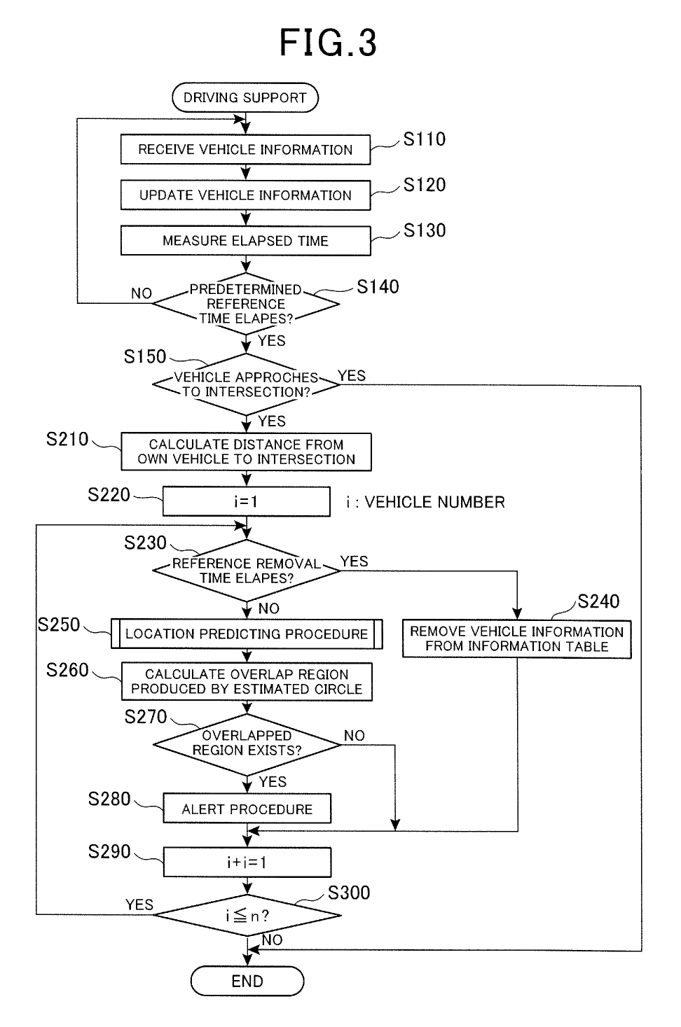

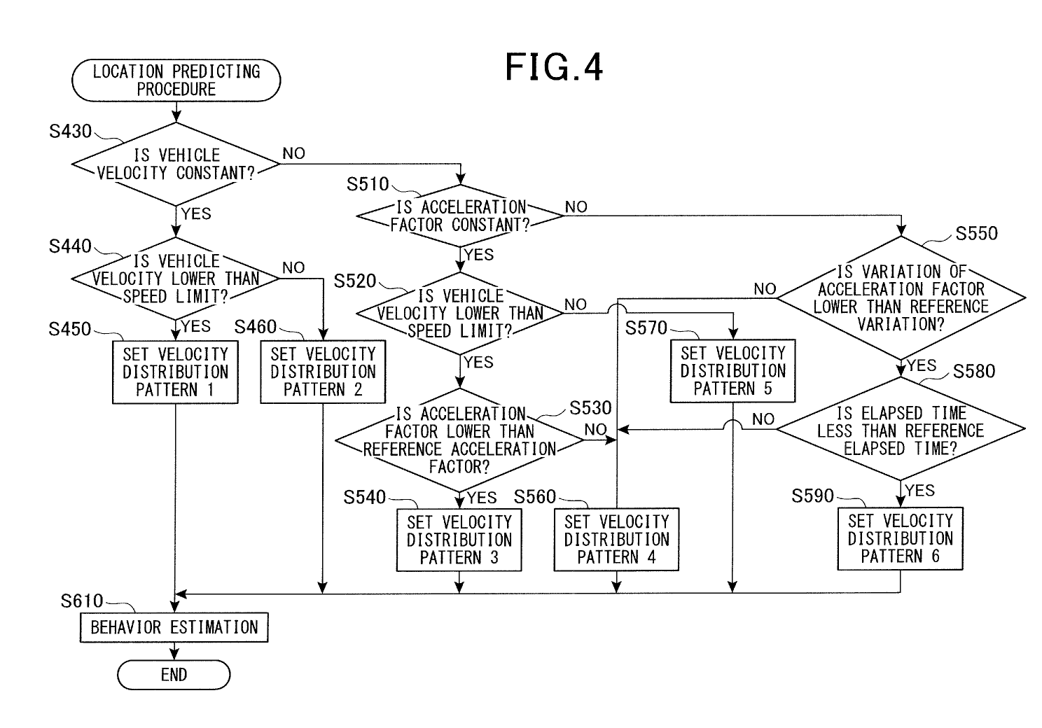

With reference to FIG. 3 and subsequent drawings, the detail processing is described as follows. FIG. 3 is a flowchart showing driving support to be executed by the processing unit 13 of the on-vehicle apparatus 10 and FIG. 4 is a flowchart showing a processing for estimating the location of the vehicle i.e., location predicting procedure, in the driving support processing.

The driving support starts when the power of the vehicle is supplied and is repeatedly executed after the power is supplied. In the driving support, the processing unit 13 attempts to receive the vehicle information at step S110. The processing unit 13 updates the vehicle information at step S120 when the vehicle information is received. In the processing at step 120, the processing unit 13 generates an information table including vehicle numbers corresponding to respective vehicle information received at step 110 and time information indicating the time when the vehicle information is received.

The vehicle number is used to identify the vehicle of the respective vehicle information and the processing executed by the processing unit 13 manages the vehicle information by using the information table. Moreover, the vehicle information further includes a vehicle identification (vehicle ID) that distinguishes the vehicles. The vehicle information corresponding to the identical vehicle is accumulated for a predetermined period of time. Meanwhile, the vehicle information when the predetermined period of time elapses is overwritten.

It is noted that step S110 corresponds to vehicle-information acquiring means, factor acquiring means, other-vehicle-information acquiring means, other-vehicle-factor acquiring means, own-vehicle-information acquiring means, and own-vehicle-factor acquiring means.

The vehicle number applied to respective vehicle is a sequential number starting from one. The vehicle information transmitted by the own vehicle is applied with the vehicle number as well as the vehicle information received from other vehicle. The vehicle number 1 is applied to the own vehicle.

Subsequently, at step S130, the processing unit 13 measures elapsed time from when the last probability of collision was calculated and determines whether or not the measured elapsed time reaches a predetermined reference time which represents a period for calculating the probability of the collision at step S140. When the measured elapsed time is less than the predetermined reference time (S140: NO), the processing returns to step S110.

When the measured elapsed time reaches the predetermined reference time (S140: YES), it is determined whether or not the own vehicle approaches the intersection at step S150. The location of the intersection can be obtained by a navigation apparatus (not shown) or a roadside unit disposed road side in the road. It is noted that the distance between the vehicle and the intersection when the own vehicle is approaching, represents a distance in which the driver is able to avoid collision between the own vehicle and the other vehicle in response to the alert output. For instance, the distance is approximately 150 meter or less.

When the own vehicle is not approaching the intersection (S150: NO), the driving support is terminated immediately. When the own vehicle is approaching to the intersection (S150: YES), the processing unit 13 calculates a required time (estimated area) for the own vehicle to reach the intersection at step S210. In this procedure, the distance from the own vehicle to the intersection is calculated based on the current location of the own vehicle and the location of the intersection, and the calculated distance is divided by the velocity of the own vehicle (vehicle velocity) so as to obtain the required time to reach the intersection.

The velocity of the own vehicle used for the calculation is set to be a velocity where the own vehicle reaches the latest to the intersection, e.g. one half of the current velocity. In the following steps, the processing determines if the own vehicle collides with other vehicle in a period from the current time to a time when the vehicle reaches the intersection.

Next, at step S220, the vehicle number i is set to be 1. Then, at step 230, it is determined whether or not a reference time for removal (i.e., reference removal time) elapses (e.g. around 1 second) for the vehicle information corresponding to the vehicle number currently set (hereinafter referred to as current vehicle number). Here, the reference removal time is used for determine whether or not the vehicle exists. That is to say, when a vehicle has not been transmitting the vehicle information for a certain period of time, e.g. more than the reference removal time, it is possible that the vehicle stopped or changed its running direction just before the intersection so that the vehicle will not enter the intersection. Therefore, the vehicle is excluded from the processing.

When the reference removal time elapses (S230: YES), the processing unit 13 removes the vehicle information corresponding to the current vehicle number in the information table at step S240 and proceeds to step 290 as described later. On the other hand, when the reference removal time has not elapsed (S230: NO), the processing unit 13 performs the location predicting procedure that predicts the location of the vehicle (vehicle-location) at step S250 (corresponds to location predicting means, other-vehicle-location predicting means, own-vehicle-location predicting means).

As shown in FIG. 4, in the location predicting procedure, at step S430, it is determined whether or not the velocity of the vehicle (vehicle velocity) corresponding to the current vehicle number is constant. When the velocity of the vehicle is constant (S430: YES), the processing compares the velocity of the vehicle with the speed limit of the road where the vehicle is running at step S440. The speed limit of the road can be obtained by the navigation apparatus or the like.

When the vehicle velocity is lower than the speed limit (S440: YES), the processing unit 13 sets the velocity distribution of pattern 1 to be used for the current processing (S450) and proceeds to step S610 which is described later. Regarding the velocity distribution (acceleration-factor distribution) 1 to 6 is described later.

However, if the vehicle velocity is higher than the speed limit (S440: YES), the processing unit 13 sets the velocity distribution to be the pattern 2 (S460) and proceeds to the step S610 which is described later. When the vehicle velocity corresponding to the current vehicle number at S430 is not constant (S430: NO), then it is determined whether or not the acceleration factor of the vehicle is constant (S510). When the acceleration factor is constant (S510: YES), the processing compares the velocity of the vehicle with the speed limit (S520).

When the vehicle velocity is lower than the speed limit (S520: YES), the processing compares the acceleration factor of the vehicle with a reference acceleration factor at step S530. When the acceleration factor of the vehicle is lower than the reference acceleration factor (S530: YES), the processing unit 13 set the velocity distribution to be the pattern 3 at step S540, and proceeds to step S610.

When the vehicle velocity is higher than or equal to the reference acceleration factor (S530: NO), the processing unit 13 set the velocity distribution to be the pattern 4 at step S560, and proceeds to step S610. At step S520, when the vehicle velocity is higher than the speed limit (S520: NO), the processing unit 13 set the velocity distribution to be the pattern 5 at step S570, and proceeds to step S610.

Subsequently, when it is determined that the acceleration factor is not constant at step S510 (S520: NO), the processing unit 13 compares an amount of variation in the acceleration factor of the vehicle with a reference variation at S550. When the variation in the acceleration factor of the vehicle is higher than or equal to the reference variation (S550: NO), the processing unit 13 set the velocity distribution to be the pattern 4 at step S560, and proceeds to step S610.

Further, the variation of the acceleration factor is lower than the reference variation (S550: YES), the processing unit compares the elapsed time counted from when the vehicle started to accelerate with the reference elapsed time at step S580. When the elapsed time from the acceleration-start is less than the reference elapsed time (S580: YES), the processing unit 13 set an acceleration-factor distribution to be the pattern 6 at step S590, and proceeds to step S610.

When the elapsed time from when the vehicle started to accelerate is more than the reference elapsed time (S580: NO), the processing unit 13 set the velocity distribution to be the pattern 4 at step S560, and proceeds to step S610.

As described, when the velocity distribution is set, the processing unit 13 estimates behavior of the vehicle based on the velocity distribution pattern which is being set (S610, vehicle-behavior predicting means). The behavior includes velocity, acceleration/deceleration and the like. The processing unit 13 estimates a location corresponding to the center of the vehicle (i.e., center value) for calculating the velocity distribution based on the vehicle velocity, acceleration factor of the vehicle, variation of the acceleration factor and yaw rate of the vehicle. Subsequently, the processing unit 13 determines a region (estimated region) where the vehicle possibly exists based on the velocity distribution pattern which is being set (region calculating means).

In the processing for estimating the location to be center value of the vehicle, following values are defined.
(X, Y): last received location (longitude, latitude, (rad))
(X′, Y′): estimated location (longitude, latitude, (rad))
v: last received velocity (longitude, latitude, (rad))
α: last received acceleration factor (m/s²), where negative value represents deceleration
Δt: elapsed time (s)
Δx, Δy: distance travelled during elapsed time (m)
Δx, Δy: distance travelled during elapsed time (longitude, latitude, rad)
θ: running direction (rad), where east direction is defined as 0 rad and increases in anticlockwise
ω: yaw rate (rad/s)
r: turning radius (m)
R: earth radius (m), approximate value at a location where vehicle runs.

With these definitions, when estimating the vehicle-location running at a constant velocity (i.e., above-described pattern 1 and 2), the location to be the center value is expressed as the following equations:

Δx =vΔt cos θ

Δy=vΔt sin θ

ΔX=Δx/(R cos Y)=vΔt cos θ/(R cos Y)

ΔY=Δy/R=vΔt sin θ/R

X′=X+ΔX=X+vΔt cos θ/(R cos Y)

Y′=Y+ΔY=Y+vΔt sin θ/R

Then, the processing unit 13 executes a processing to obtain the estimated region. In the processing, the processing unit 13 calculates a probability of velocity variation from the calculated center value based on a statistics theory. According to the embodiment, the normal distribution is employed for the above-described processing.

The normal distribution (μ, σ²) is calculated from the following equation (1), where μ, σ², σ denote a mean value (center value), a variance, and a standard deviation respectively.

$$f ( x ) = \frac{1}{{( 2 π )}^{\frac{1}{2}} σ} exp \{ - {( x - μ )}^{2} / 2 {σ}^{2} \} \qquad ( 1 )$$

Although the equation 1 defines the normal distribution, when the distribution is asymmetry at a boundary where x=μ, the following equations can be defined.

$$\begin{matrix}f ( x ) = \frac{a}{{( 2 π )}^{\frac{1}{2}} {σ}_{1}} exp \{ - {( x - μ )}^{2} / 2 {σ}_{1}^{2} \} & ( x \leq μ ) \\ = \frac{b}{{( 2 π )}^{\frac{1}{2}} {σ}_{2}} exp \{ - {( x - μ )}^{2} / 2 {σ}_{2}^{2} \} & ( x \geq μ )\end{matrix} \qquad \begin{matrix}\begin{matrix}( 2 ) \\ \end{matrix} \\ ( 3 )\end{matrix}$$

when x=μ is satisfied, the equations are:

$$\begin{matrix}\frac{a}{{( 2 π )}^{\frac{1}{2}} {σ}_{1}} exp \{ - \frac{{( μ - μ )}^{2}}{2 {σ}_{1}^{2}} \} = \frac{b}{{( 2 π )}^{\frac{1}{2}} {σ}_{2}} exp \{ \frac{- {( μ - μ )}^{2}}{2 {σ}_{2}^{2}} \} & ( 4 ) \\ \frac{b}{a} = \frac{{σ}^{2}}{{σ}^{1}} & ( 5 )\end{matrix}$$

Hence, when the function is integrated by using the Gauss integration formula, the equations are represented as:

$$\begin{matrix}{\int }_{- ∞}^{+ ∞} f ( x ) d x = {\int }_{- ∞}^{μ} \frac{a}{{( 2 π )}^{\frac{1}{2}} {σ}_{1}} exp \{ \frac{- {( x - μ )}^{2}}{2 {σ}_{1}^{2}} \} d x + \\ {\int }_{μ}^{+ ∞} \frac{b}{{( 2 π )}^{\frac{1}{2}} {σ}_{2}} exp \{ \frac{- {( x - μ )}^{2}}{2 {σ}_{1}^{2}} \} d x \\ = \frac{a}{2 {( 2 π )}^{\frac{1}{2}} {σ}_{1}} {( 2 π )}^{\frac{1}{2}} {σ}_{1} + \frac{b}{2 {( 2 π )}^{\frac{1}{2}} {σ}_{2}} {( 2 π )}^{\frac{1}{2}} {σ}_{2} \\ = \frac{a}{2} + \frac{b}{2} = 1\end{matrix} \qquad \begin{matrix}\begin{matrix}\begin{matrix}\begin{matrix}\begin{matrix}( 6 ) \\ \end{matrix} \\ \end{matrix} \\ \end{matrix} \\ \end{matrix} \\ \begin{matrix}\begin{matrix}( 7 ) \\ \end{matrix} \\ ( 8 )\end{matrix}\end{matrix}$$

Here, according to the above equations (7) and (8), the following equations are given.

$$\begin{matrix}a = \frac{2 {σ}_{1}}{{σ}_{1} + {σ}_{2}} & ( 9 ) \\ b = \frac{2 {σ}_{2}}{{σ}_{1} + {σ}_{2}} & ( 10 )\end{matrix}$$

When substituting the equations (9) and (10) for the equations (2) and (3), the following equations (11) and (12) are given.

$$\begin{matrix}f ( x ) = \frac{2}{{( 2 π )}^{\frac{1}{2}} ( {σ}_{1} + {σ}_{2} )} exp \{ - {( x - μ )}^{2} / 2 {σ}_{1}^{2} \} & ( x \leq μ ) \\ = \frac{2}{{( 2 π )}^{\frac{1}{2}} ( {σ}_{1} + {σ}_{2} )} exp \{ - {( x - μ )}^{2} / 2 {σ}_{2}^{2} \} & ( x \geq μ )\end{matrix} \qquad \begin{matrix}\begin{matrix}( 11 ) \\ \end{matrix} \\ ( 12 )\end{matrix}$$

Subsequently, when the vehicle velocity is constant (i.e., above-described pattern 1 and 2), assuming the vehicle velocity changes i.e., the acceleration changes from 0 to α whereby the vehicle-location shifts, an amount of shift is expressed as the following equations (13) and (14).

Δx=(vΔt+αΔt²/2)cos θ (13)

Δy=(vΔt+αΔt²/2)sin θ (14)

According to the above-described equations (11) and (12), it is assumed that the acceleration factor α is represented as a probability distribution as follows.

$$\begin{matrix}f ( α ) = \frac{2}{{( 2 π )}^{\frac{1}{2}} ( {σ}_{1} + {σ}_{2} )} exp ( - {α}^{2} / 2 {σ}_{1}^{2} ) & ( α \leq μ ) \\ = \frac{2}{{( 2 π )}^{\frac{1}{2}} ( {σ}_{1} + {σ}_{2} )} exp ( - {α}^{2} / 2 {σ}^{2} ) & ( α \geq μ )\end{matrix} \qquad \begin{matrix}\begin{matrix}( 15 ) \\ \end{matrix} \\ ( 16 )\end{matrix}$$

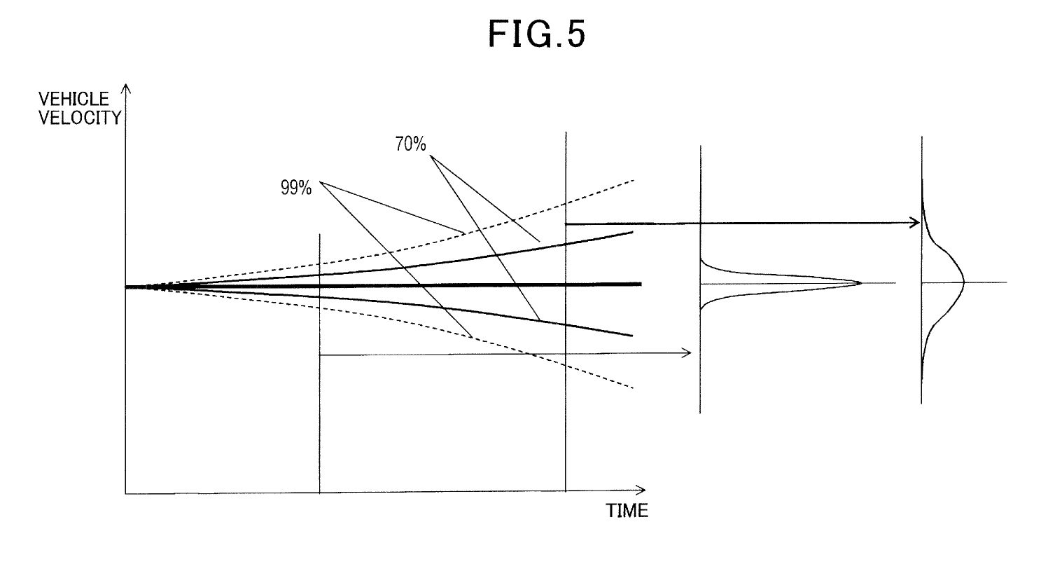

It is noted that σ₁ and σ₂ represents the standard deviations defined by based on a running condition of the vehicle. Using above-described equations (15) and (16), when the velocity distribution pattern 1 is set, the standard deviation σ₁ equals to σ₂ (σ₁=σ₂), the velocity distribution is obtained as shown in FIG. 5. Referring to FIG. 5, the horizontal line shows time and the vertical line shows vehicle velocity, and the larger the time, the larger the fluctuation of the vehicle velocity.

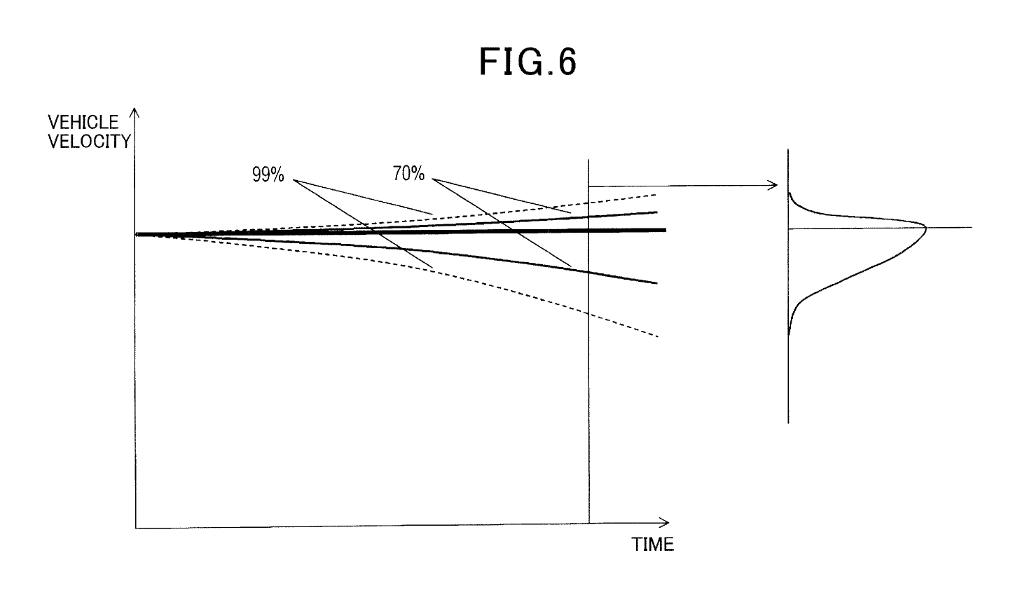

In FIG. 5 and subsequent drawings FIGS. 6 to 9 and 10A, 10B, thick solid line indicates center value of the vehicle velocity and a range specified by two dotted lines includes 99% of velocity variation values, which corresponds to 3σ. Further, a range specified by two thin solid lines includes 70% of velocity variation values, which corresponds to one σ.

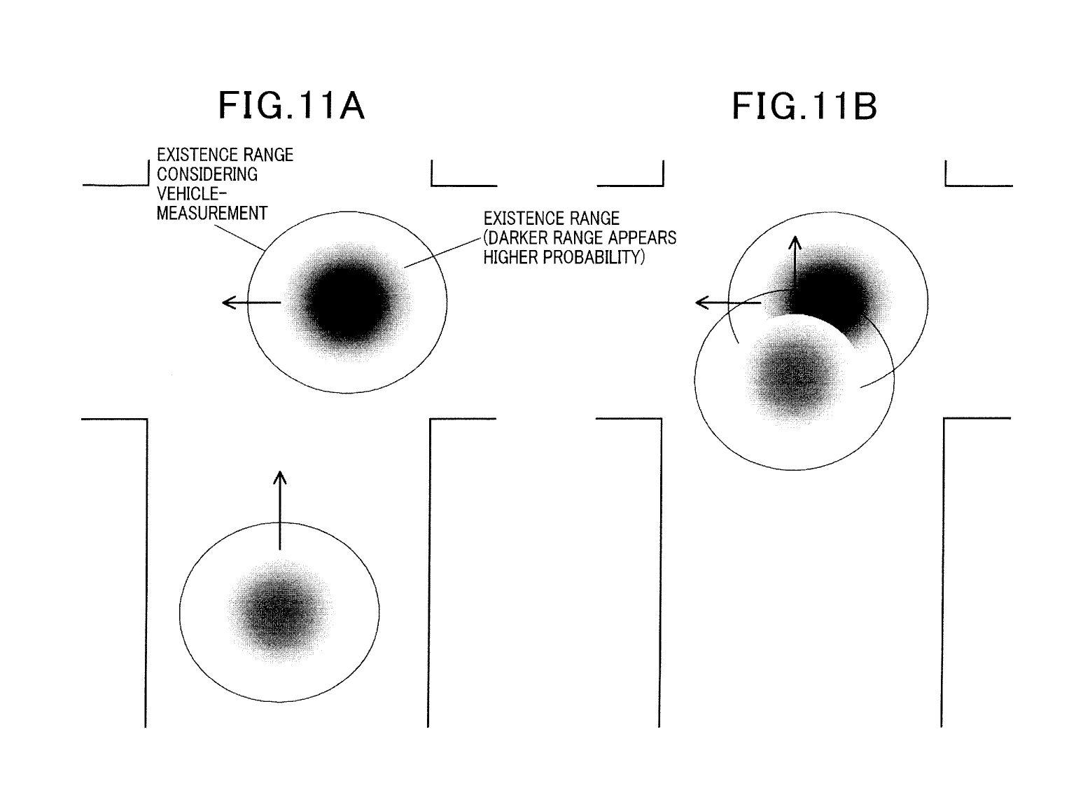

Thus, by using the velocity distribution, the processing unit 13 calculates the estimated regions (see FIGS. 2A, 2B and FIGS. 11A, 11B) having a plurality of regions where the vehicles being currently set may exist. The processing unit 13 calculates respective estimated regions at a predetermined period (e.g. every 0.2 second) for an area defined by the current time to the time when the vehicle reaches the intersection. Each of the plurality of regions is discriminated by probability of possible existing vehicle. In other word, behavior of the vehicle is calculated.

When the velocity distribution defined by pattern 2 is set, the vehicle velocity already reaches the speed limit so that the processing unit 13 estimates the probability of the vehicle being currently accelerating to be low and sets the standard deviation of the acceleration side to be lowered in the equations (15) and (16). Then, as shown in FIG. 6, the velocity distribution in which the probability of the acceleration side is lowered can be obtained.

When the velocity distribution defined by the pattern 3 is set, the acceleration factor of the vehicle is constant so that the location of the center value is expressed as the following equations:

Δx=(vΔt+αΔt²/2)cos θ

Δy(vΔt+αΔt²/2)sin θ

ΔX=Δx/(R cos Y)=(vΔt+αΔt²/2)cos θ/(R cos Y)

ΔY=Δy/R=(vΔt+αΔt²/2)sin θ/R

X′=X+ΔX=X+(vΔt+αΔt²/2)cos θ/(R cos Y)

Y′=Y+ΔY=Y+(vΔt+αΔt²/2)sin θ/R

In the processing to calculate the estimated region, considering a location shift when assuming the velocity changes i.e., the acceleration factor changes α₁ to α, the velocity distribution is expressed as following equations (17) and (18).

$$\begin{matrix}f ( α ) = \frac{2}{{( 2 π )}^{\frac{1}{2}} ( {σ}_{1} + {σ}_{2} )} exp \{ - {( α - {α}_{0} )}^{2} / 2 {σ}_{1}^{2} \} & ( α \leq {α}_{0} ) \\ = \frac{2}{{( 2 π )}^{\frac{1}{2}} ( {σ}_{1} + {σ}_{2} )} exp \{ - {( α / {α}_{0} )}^{2} / 2 {σ}_{2}^{2} \} & ( α \geq {α}_{0} )\end{matrix} \qquad \begin{matrix}\begin{matrix}( 17 ) \\ \end{matrix} \\ ( 18 )\end{matrix}$$

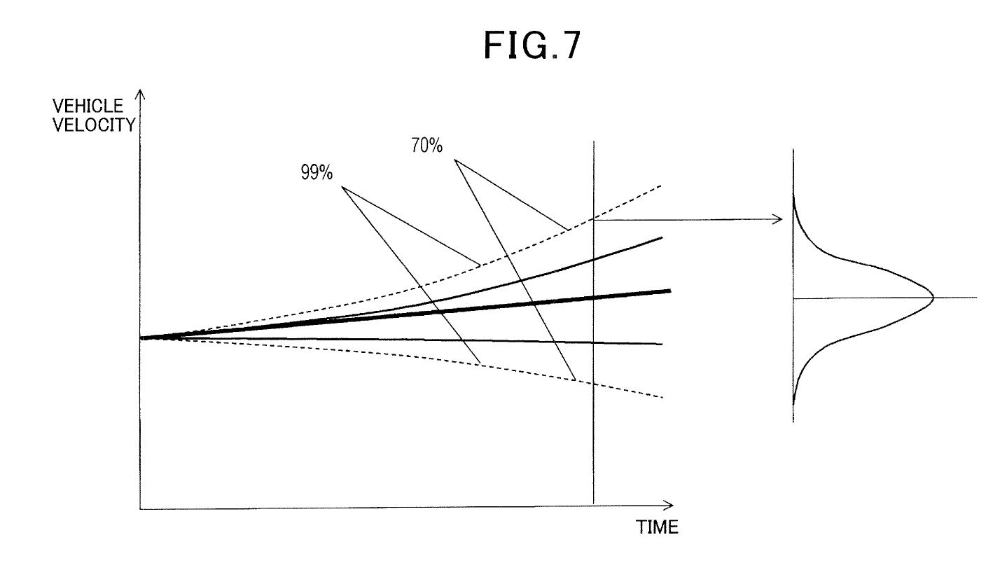

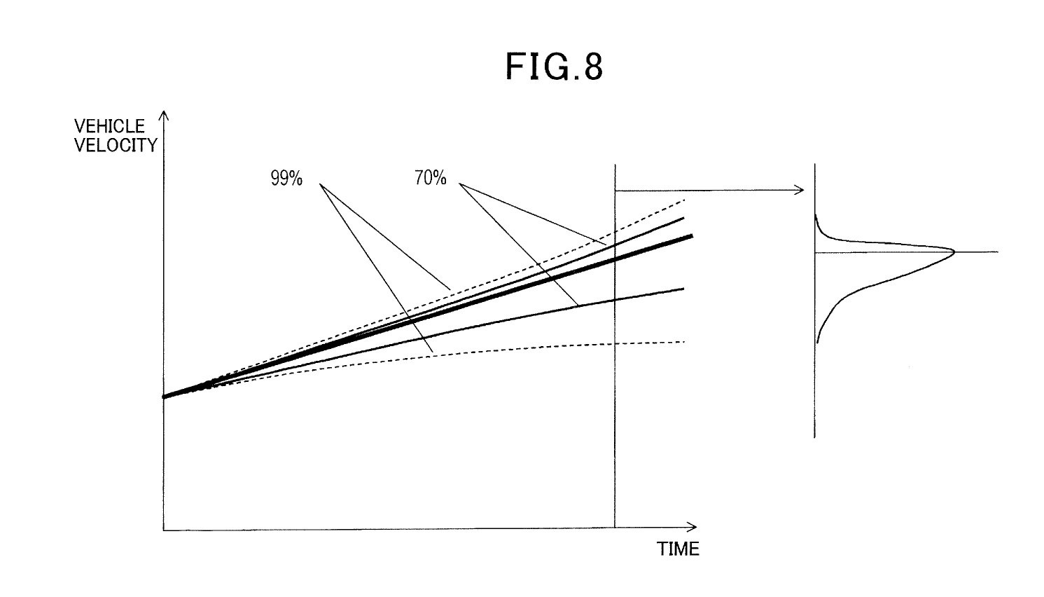

In this condition, as shown in FIG. 7, it is assumed that the velocity distribution will be the normal distribution. When the velocity distribution pattern 4 is defined, it is considered that the acceleration factor is already high and the probability of further increasing of the acceleration is low. Hence, the processing unit 13 sets the standard deviation of acceleration side to be lower. Then, as shown in FIG. 8, asymmetric velocity distribution is obtained.

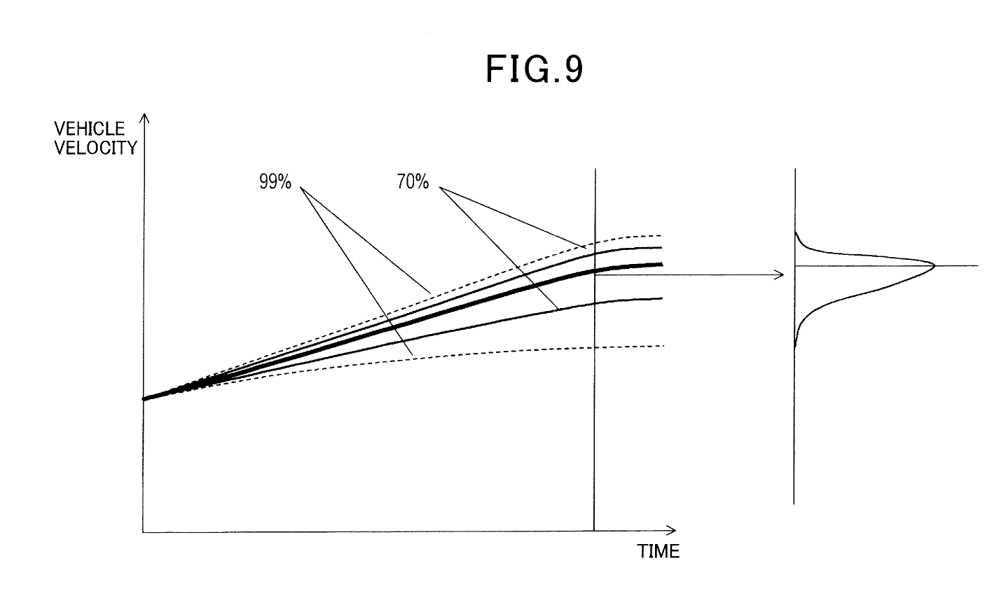

Subsequently, when the center value reaches the speed limit, the processing unit assumes that the vehicle runs at a constant velocity. Accordingly, after the velocity reaches the speed limit, as shown in FIG. 9, the velocity distribution becomes similar to the distribution shown in pattern 2.

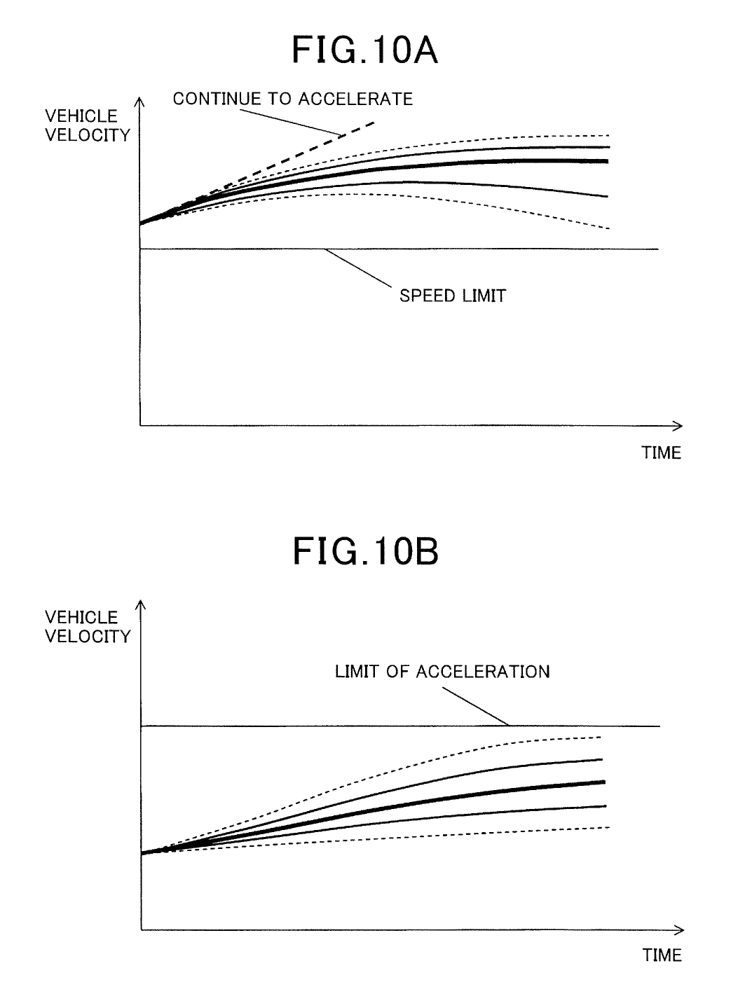

When the velocity distribution pattern 5 is set, it is considered that the vehicle velocity exceeds the speed limit and the probability of increasing the acceleration is low so that the processing unit 13 sets the standard deviation of the acceleration side to be lower. Then, when the difference between the vehicle velocity and the speed limit becomes larger, the processing unit 13 sets the acceleration factor to be negative direction. In other word, the processing unit 13 adjusts the center value towards the negative direction. As a result, an asymmetric velocity distribution as shown in FIG. 10A is obtained.

Furthermore, when the velocity distribution pattern 6 is set, since the vehicle velocity is not constant, the location to be the center value is represented as:

Δx=(vΔy+α₀Δt²/2+βΔt³/4)cos θ

Δy=(vΔt+α₀Δt²/2+βΔt³/4)sin θ

ΔX=Δx/(R cos Y)=(vΔt+α₀Δt²/2+βΔt³/4)cos θ/(R cos Y)

ΔY=Δy/R=(vΔt+α₀Δt²/2+βΔt³/4)sin θ/R

X′=X+ΔX=X+(vΔt+α₀Δt²/2+βΔt³/4)cos θ/(R cos Y)

Y′=Y+ΔY=Y+(vΔt+α₀Δt²/2+βΔt³/4)sin θ/R

where β represents a change of the acceleration factor, and the acceleration factor α is expressed as the following equation:

α=α₀+βΔt/2

where α₀ represents last-received acceleration factor, and the coefficient ½ is used to average the value of acceleration factor between Δt periods.

Next, at the calculating the estimated regions, assuming the acceleration factor changes i.e., a change of the acceleration factor changes from β₀ to β whereby the vehicle-location shifts, the acceleration-factor distribution can be expressed as following equations (19) and (20).

$$\begin{matrix}f ( β ) = \frac{2}{{( 2 π )}^{\frac{1}{2}} ( {σ}_{1} + {σ}_{2} )} exp \{ - {( β - {β}_{0} )}^{2} / 2 {σ}_{1}^{2} \} & ( β \leq {β}_{0} ) \\ = \frac{2}{{( 2 π )}^{\frac{1}{2}} ( {σ}_{1} + {σ}_{2} )} exp \{ - ( β / {β}_{0}^{2} ) / 2 {σ}_{2}^{2} \} & ( β \geq {β}_{0} )\end{matrix} \qquad \begin{matrix}\begin{matrix}( 19 ) \\ \end{matrix} \\ ( 20 )\end{matrix}$$

Considering the above-described equations, the relationship between time and the acceleration factor is expressed as shown in FIG. 10B. However, in these equations, the acceleration factor is unlikely to increase continuously and each acceleration factor in the respective vehicles is limited which is determined by vehicle performance. Therefore, center value of the acceleration factor is adjusted to be gradually decreased. Since the change of the acceleration factor is hardly expected, the processing unit 13 sets the standard deviation to be larger than the one from other patterns.

In the above-described processing, it is described that the own vehicle accelerates, however, the processing can be applied when the own vehicle decelerates. When the location predicting procedure is completed, the processing unit 13 calculates a region where the estimated regions (estimated circle) obtained by the location predicting procedure are mutually overlapped (S260: region calculating means, collision calculating means). Here, overlapping of the estimated regions is defined as an overlapping of the estimated region of the own vehicle and the estimated regions of other vehicle corresponding to the current vehicle number. When the current vehicle number is set as the own vehicle (1 in this embodiment), this processing is omitted.

Subsequently, at step S270, the processing unit 13 determines whether or not the estimated regions mutually overlap (determining means). When the overlapped region exists (S270: YES), an alert procedure that allows the alert unit 14 to output an alert is activated (S280: alert means). In the alert procedure, types of alert may be changed depending on the probability of collision between the own vehicle and other vehicles. The probability of collision can be calculated based on the area of the overlapped region or probability of respective vehicles existing in the overlapped region.

As shown in FIGS. 2A-2B, 11A-11B, the probability of respective vehicles existing becomes higher when the vehicles approach the center of the estimated regions. Hence, when overlapped area of estimated region becomes larger, the probability of the collision may increase.

Next, the processing unit 13 increments the vehicle number i (S290), and compares maximum vehicle number n in the information table with the current vehicle number i at step S300. When the current vehicle number i is smaller than or equal to the maximum vehicle number n (S300: YES), the processing unit 13 repeatedly executes processing at step 230 and the subsequent steps. Meanwhile, when the current vehicle number i is larger than the maximum vehicle number n, the processing unit 13 terminates the driving support.

### Advantages of the Embodiment

In the on-vehicle apparatus 10 as described above, the processing unit 13 performs the driving support such that the processing unit 13 acquires vehicle information for subject vehicles (i.e., own vehicle and other vehicles) at a predetermined time. The vehicle information includes location, velocity, running direction of the vehicle and a factor that changes the velocity of the subject vehicles as well. It is noted that the inter-vehicle communication is used for acquiring the vehicle information of other vehicles. Based on the factor that changes the velocity of the subject vehicles, the processing unit 13 estimates the location of the subject vehicles at a plurality of future object times advanced from the predetermined time.

According to the above-described on-vehicle apparatus 10, since the processing unit 13 estimates the location of the subject vehicle based on the factor that changes the velocity of the subject vehicle, accuracy of estimating the vehicle-location can be enhanced compared to estimating the vehicle running at a constant velocity. Further, the processing unit 13 employs vehicle information regarding other vehicles via inter-vehicle communication thereby estimating the location of other vehicle as well as the location of the own vehicle.

Further, the processing unit 13 of the on-vehicle apparatus 10 estimates behavior of the own vehicle and other vehicles based on the estimated locations for the own vehicle and other vehicles. Then, the processing unit 13 calculates the probability of collision between the own vehicle and other vehicles based on the estimated behavior.

According to the above-described on-vehicle apparatus 10, detecting accuracy of the vehicle-location can be enhanced so that accuracy of the calculation used for calculating the probability of collision can be enhanced as well. The processing unit 13 calculates the estimated regions having a plurality of regions discriminated by probability of possible existing vehicle based on the estimated locations where the own vehicle and other vehicles are likely to exist at a plurality of future object times advanced from the predetermined time. Then, the processing unit 13 determines the probability of collision based on how the respective estimated regions overlap at the same timing.

Thus, according to the on-vehicle apparatus 10, the probability of the collision can readily be determined depending on an amount of area overlapped in the respective estimated regions. Further, the processing unit 13 can output an alert in response to the probability of collision.

According to the on-vehicle apparatus 10, since the processing unit 13 is adapted to output an alert in response to the calculation result of the probability of collision, the driver can be notified of the possible collision by the alert. Moreover, the processing unit 13 acquires the speed limit information of the road where the subject vehicle runs so as to recognize the increasing velocity. Then, the processing unit 13 estimates the location of the subject vehicle since the probability of the velocity exceeding the speed limit is considered to be low.

The processing unit 13 is adapted to estimate the location of the subject vehicle assuming a low probability of the velocity of the vehicle exceeding the speed limit whereby the detecting accuracy of the subject vehicle can be enhanced.

Further, the processing unit 13 of the on-vehicle apparatus 10 acquires information as a factor that increases the velocity, i.e., information concerning the acceleration/deceleration capability of the subject vehicle, estimates the velocity of the subject vehicle based on the acquired information and estimates the location of the subject vehicle.

According to the above-described on-vehicle apparatus 10, acceleration/deceleration range i.e., velocity range can be estimated based on the acceleration/deceleration capability of the subject vehicle so that accuracy of detecting location of the subject vehicle can be enhanced.

### Other Embodiments

The present invention is not limited to the above-described embodiments, however, can be modified in various ways as long as the present invention does not depart from the spirit of the invention.

For instance, according to the above-described embodiment, the normal distribution is employed for calculating a variation of the vehicle-location. However, other techniques can be employed to calculate the variation of the vehicle-location. Moreover, according to the above-described embodiment, the on-vehicle apparatus calculates probability of collision between the own vehicle and other vehicles. However, the calculation can be made for a probability of collision between other vehicles. In this instance, other vehicles may be notified of the information concerning possible collision, such as the probability of collision.

In the above-described embodiments, the alert is issued depending on the probability of collision. However, when the probability of collision is higher than a predetermined threshold value, the vehicle control unit 15 may perform braking operation to stop the own vehicle.

According to the above-describe embodiments, a shift of vehicle-location when the vehicle is rotating is excluded in the consideration. However, a shift of the vehicle location can be taken into consideration. In this situation, the following equations can be used to calculate the center value or the velocity distribution.

ΩrΔt=(v+αΔt/2)Δt

r=(v+αΔt/2)/ω

d=2r sin(ωΔt/2)=(2v+αΔt)/ω sin(ωΔt/2)

Δx=(2v+αΔt)/ω sin(ωΔt/2)cos(θ+ωΔt/2)

Δy=(2v+αΔt)/ω sin(ωΔt/2)sin(θ+ωΔt/2)

ΔX=(2v+αΔt)/ω sin(ωΔt/2)cos(θ+ωΔt/2)/(R cos Y)

ΔY=(2v+αΔt)/ω sin(ωΔt/2)sin(θ+ωΔt/2)/R

X′=X+(2v+αΔt)/ω sin(ωΔt/2)cos(θ+ωΔt/2)/(R cos Y)

Y′=Y+(2v+αΔt)/ω sin(ωΔt/2)sin(θ+ωΔt/2)/R

According to this configuration, similar advantages of the above-described embodiments can be obtained.

What is claimed is:

1. A location-estimating apparatus estimating a location of a subject vehicle, the apparatus comprising:
vehicle-information acquiring means for acquiring information about the subject vehicle at a reference time, the information including a location, a velocity and a running direction of the subject vehicle;
factor acquiring means for acquiring a factor that changes the velocity of the subject vehicle; and
location predicting means for predicting a location of the subject vehicle at an object time which is advanced from the reference time.

2. The location-estimating apparatus according to claim 1, wherein the vehicle-information acquiring means comprises other-vehicle-information acquiring means for acquiring the information about other vehicles as the subject vehicle by using an inter-vehicle communication, and the location predicting means comprises other-vehicle-location predicting means for predicting the location about other vehicle by using the inter-vehicle communication.

3. The location-estimating apparatus according to claim 1, wherein the location-estimating apparatus is mounted on a vehicle, the vehicle-information acquiring means comprises own-vehicle-information acquiring means for acquiring the information about an own vehicle as the subject vehicle, the factor acquiring means comprises own-vehicle-factor acquiring means for acquiring the factor that changes the velocity of the own vehicle, and the location predicting means comprises own-vehicle-location predicting means for predicting the location of the own vehicle.

4. The location-estimating apparatus according to claim 2, wherein the location-estimating apparatus is mounted on a vehicle, the vehicle-information acquiring means comprises own-vehicle-information acquiring means for acquiring the information about an own vehicle as the subject vehicle, the factor acquiring means comprises own-vehicle-factor acquiring means for acquiring the factor that changes the velocity of the own vehicle, and the location predicting means comprises own-vehicle-location predicting means for predicting the location of the own vehicle.

5. The location-estimating apparatus according to claim 3, further comprising:
vehicle-behavior predicting means for predicting a behavior of the own vehicle and other vehicle; and
collision calculating means for calculating a probability of collision between the own vehicle and other vehicle based on the behaviors predicted by the vehicle-behavior predicting means.

6. The location-estimating apparatus according to claim 5,
the vehicle-behavior predicting means further comprising: region calculating means for calculating regions at a plurality of object times advanced from the reference time, the regions being specified such that the own vehicle and other vehicles are likely to exist therein and having plural regions discriminated by a probability of the own vehicle and other vehicles to be existed; and
the collision calculating means comprises determining means for determining the probability of collision based on whether or not the regions mutually overlap at each of the object times.

7. The location-estimating apparatus according to claim 5, further comprising alert means configured to generate an alert in response to the probability of collision and to give the alert.

8. The location-estimating apparatus according to claim 6, further comprising alert means configured to generate an alert in response to the probability of collision and to give the alert.

9. The location-estimating apparatus according to claim 1, wherein the factor acquiring means is configured to acquire speed limit information as the factor that changes the velocity of the subject vehicle, and the location predicting means is configured to predict the location of the subject vehicle assuming the velocity of the subject vehicle is unlikely to accelerate to exceed the speed limit.

10. The location-estimating apparatus according to claim 1, wherein the factor acquiring means is configured to acquire information about acceleration/deceleration capability of the subject vehicle, and the location predicting means is configured to predict the velocity of the subject vehicle based on the information about the acceleration/deceleration capability and to predict the location of the subject vehicle.

11. A location-estimating program that estimates a location of an subject vehicle executed on a location-estimating apparatus, the program comprising:
vehicle-information acquiring program for acquiring information about the subject vehicle at a reference time, the information including a location, a velocity and a running direction of the subject vehicle;
factor acquiring program for acquiring a factor that changes the velocity of the subject vehicle; and
location predicting program for predicting a location of the subject vehicle at an object time which is advanced from the reference time.

12. The location-estimating program according to claim 11, wherein the vehicle-information acquiring program comprises other-vehicle-information acquiring program for acquiring the information about an other vehicle as the subject vehicle by using an inter-vehicle communication, and the location predicting program comprises other-vehicle-location predicting program for predicting the location about other vehicle by using the inter-vehicle communication.

13. The location-estimating program according to claim 12, wherein the location-estimating apparatus is mounted on a vehicle, the vehicle-information acquiring program comprises own-vehicle-information acquiring program for acquiring the information about an own vehicle as the subject vehicle, the factor acquiring program comprises own-vehicle-factor acquiring program for acquiring the factor that changes the velocity of the own vehicle, and the location predicting program comprises own-vehicle-location predicting program for predicting the location of the own vehicle.

14. The location-estimating program according to claim 13, further comprising:
vehicle-behavior predicting program for predicting a behavior of the own vehicle and other vehicle; and
collision calculating program for calculating a probability of collision between the own vehicle and other vehicle based on the behaviors predicted by the vehicle-behavior predicting program.
